(19) United States
(12) Patent Application Publication
(10) Pub. No.: US 2014/0156882 A1
(43) Pub. Date: Jun. 5, 2014

(54) MEMORY DEVICE, OPERATING METHOD THEREOF, AND DATA STORAGE DEVICE INCLUDING THE SAME

(71) Applicant: SK HYNIX INC., Icheon-si (KR)

(72) Inventors: Eui Sang YOON, Icheon-si (KR); Young Soo PARK, Icheon-si (KR)

(73) Assignee: SK HYNIX INC., Icheon-si (KR)

(21) Appl. No.: 13/846,072

(22) Filed: Mar. 18, 2013

(30) Foreign Application Priority Data
Dec. 4, 2012 (KR) 10-2012-0139445

(51) Int. Cl. G06F 5/06; G06F 13/28

(52) U.S. Cl. CPC G06F 5/065; G06F 13/28
USPC 710/26; 710/52

(57) ABSTRACT

A memory device includes a data read/write block configured to store data in memory cells and read data from the memory cells; an input/output buffer block configured to buffer input data inputted through data pads and control signals inputted through control signal pads, and provide buffered input data and control signals to the data read/write block, and buffer read data read out through the data read/write block, and output buffered read data to an external device through the data pads, and a control logic configured to activate or deactivate the input/output buffer block based on an address which is inputted from the external device.

### CROSS-REFERENCES TO RELATED APPLICATION

The present application claims priority under 35 U.S.C. §119(a) to Korean application number 10-2012-0139445, filed on Dec. 4, 2012, in the Korean Intellectual Property Office, which is incorporated herein by reference in its entirety.

### BACKGROUND

1. Technical Field

The present invention generally relates to a semiconductor device, and more particularly, to a multi-chip package memory device including a plurality of memory devices, and an operating method thereof.

2. Related Art

Usage of computing systems has increased drastically in the past few decades. Due to this fact, the use of portable electronic devices such as mobile phones, digital cameras, and notebook computers has rapidly increased. In general, such portable electronic devices use a data storage device comprised of a memory device within. The data storage device may be used as a main memory device or an auxiliary memory device within a portable electronic device.

A data storage device using a memory device provides advantages, since there is no mechanical driving part, such as high stability and durability, high speed information access, and small power consumption. Data storage devices having such advantages include a USB (universal serial bus) memory device, a memory card having various interfaces, and a solid state drive (SSD).

In order to reproduce large capacity files such as music files and video files in a portable electronic device, a data storage device having a large storage capacity is required. The data storage device typically includes a plurality of memory apparatuses to increase the storage capacity. Moreover, in order to increase the storage capacity of each of the plurality of memory apparatuses, each memory apparatus typically includes a plurality of memory devices (or memory dies or memory chips). The memory apparatus including the plurality of memory devices is packaged to appear as one memory apparatus unit even though several memory devices are stacked therein. The memory apparatus in which the plurality of memory devices (or memory dies or memory chips) are stacked and packaged as one memory apparatus is called a multi-chip package memory device.

In the multi-chip package memory device, operating current refers to current which is consumed when the multi-chip package memory device operates in an active mode such as in read, write (or program) and erase operations. Conversely, standby current, or leakage current, refers to current which is consumed when the multi-chip package memory device operates in a standby mode or a power saving mode. The operating current consumed by activated memory devices among the memory devices included in the multi-chip package memory device and the operating current or standby current consumed by deactivated memory devices constitute total current consumption of the entire multi-chip package memory device. That is to say, the operating current or standby current consumed by the unselected memory devices among the memory devices included in the multi-chip package memory device may serve as a factor in increasing the total current consumption of the entire multi-chip package memory device.

### SUMMARY

In an embodiment of the present invention, a memory device includes: a data read/write block configured to store data in memory cells and read data from the memory cells, an input/output buffer block configured to buffer data which are provided from the data read/write block or to the data read/write block, and a control logic configured to activate or deactivate the input/output buffer block based on an address which is inputted from the external device.

In an embodiment of the present invention, the control logic includes an address pre-decoder configured to pre-decode the inputted address, and the control logic is configured to determine whether the inputted address is included in an operating address range allocated to access the memory device, based on a decoding result of the address pre-decoder.

In an embodiment of the present invention, the control logic is configured to deactivate the input/output buffer block when it is determined that the inputted address is not included in the operating address range.

In an embodiment of the present invention, an operating method of a memory device includes: receiving an address, pre-decoding the received address, determining whether the received address is included in an operating address range allocated for accessing the memory device, based on a result of pre-decoding the received address; and controlling an input/output buffer block of the memory device depending on whether the input/output buffer block of the memory device is activated or deactivated, based on the determining result.

In an embodiment of the present invention, the input/output buffer block is deactivated when it is determined that the received address is not included in the operating address range.

In an embodiment of the present invention, a data storage device includes: a multi-chip package memory device including a plurality of memory devices, and a controller configured to control the multi-chip package memory device, wherein each of the plurality of memory devices comprises: a data read/write block configured to store data in memory cells and read data from the memory cells; an input/output buffer block configured to buffer input data inputted through data pads and control signals inputted through control signal pads, provide buffered input data and control signals to the data read/write block, and buffer read data read out through the data read/write block, and output buffered read data to an external device through the data pads; and a control logic configured to activate or deactivate the input/output buffer block based on an address which is inputted from the external device.

In an embodiment of the present invention, a data storage device includes: a multi-chip package device including a plurality of semiconductor chips, wherein each of the semiconductor chips includes a data read/write block configured to store data in memory cells and read data from the memory cells, an input/output buffer block configured to buffer data provided from or to the read/write block, and a control logic configured to control a driving of the input/output buffer block; and a controller configured to provide control signals to the multi-chip package memory device, wherein the control logic of non-selected semiconductor chips is configured to block operations of the input/output buffer blocks using a pre-decoded address, when one of the plurality of semiconductor chips is selected according to the control signals.

### BRIEF DESCRIPTION OF THE DRAWINGS

Features, aspects, and embodiments are described in conjunction with the attached drawings, in which:

FIG. 1 is a perspective view showing memory chips included in a multi-chip package memory device in accordance with an embodiment of the present invention;

FIG. 2 is a table showing a way of distinguishing access addresses of the memory chips included in the multi-chip package memory device in accordance with an embodiment of the present invention;

FIG. 3 is a block diagram showing a memory die included in the multi-chip package memory device in accordance with an embodiment of the present invention;

FIG. 4 is a block diagram showing the input/output buffer block of the memory die shown in FIG. 3;

FIG. 5 is a flow chart showing an operating method of the memory die included in the multi-chip package memory device in accordance with an embodiment of the present invention;

FIG. 6 is a block diagram showing a data processing system including the multi-chip package memory device in accordance with an embodiment of the present invention;

FIG. 7 is a diagram showing a memory card including the multi-chip package memory device in accordance with an embodiment of the present invention;

FIG. 8 is a block diagram showing the internal configuration of the memory card shown in FIG. 7 and the connection relationship between the memory card and a host;

FIG. 9 is a block diagram showing an SSD including the multi-chip package memory device in accordance with an embodiment of the present invention;

FIG. 10 is a block diagram showing the SSD controller shown in FIG. 9; and

FIG. 11 is a block diagram showing a computer system in which a data storage device including the multi-chip package memory device in accordance with an embodiment of the present invention is mounted.

### DETAILED DESCRIPTION

In the present invention, advantages, features and methods will become more apparent after a reading of the following embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element, or with intervening elements present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

Hereinafter, a memory device, an operating method thereof, and a data storage device including the same according to the present invention will be described below with reference to the accompanying drawings through various embodiments.

Referring to FIG. 1, a multi-chip package memory device 500 may include a plurality of memory chips 100 and 200. Memory chips may be referred to as memory devices, and hereinafter, the memory chips will be referred to as memory dies. For the sake of convenience in explanation, the multi-chip package memory device constituted by two memory dies 100 and 200 will be exemplified. However, it is to be readily appreciated that the number of memory dies included in the multi-chip package memory device 500 may vary according to the storage capacity needs of the multi-chip package memory device 500.

Pads of the first die 100, excluding stack pads for applying stack signals, may be connected with pads of the second die 200. For example, chip enable signal (CE) pads, control signal pads, data pads and power (Vcc and GND) pads of the memory dies 100 and 200 may be connected with each other. According to such a connection structure, the multi-chip package memory device 500 may be known as a 1-CE multi-chip package memory device which is activated by one chip enable signal (CE) (or a chip select signal) provided from an external device (for example, a memory controller, a host device, and so forth).

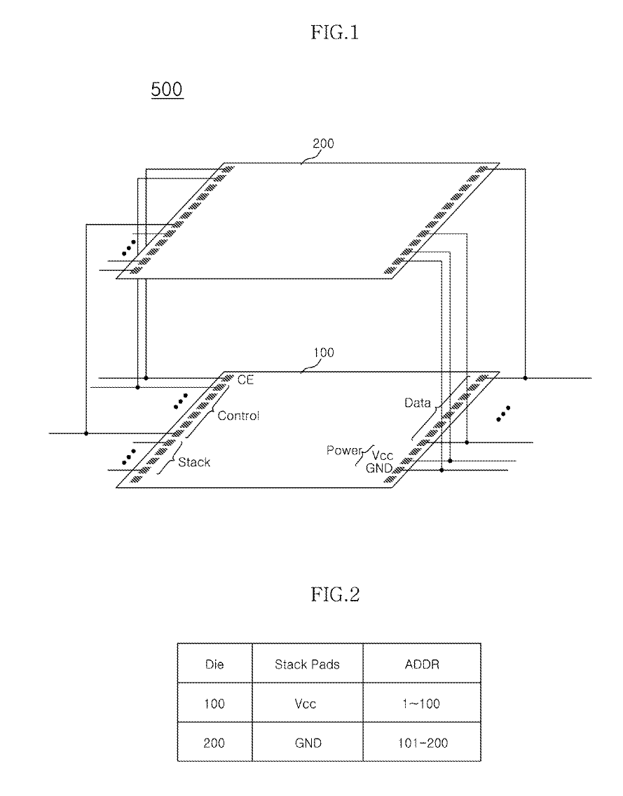

Access to addresses of the memory dies 100 and 200 of the 1-CE multi-chip package memory device 500 may be controlled according to the stack signals applied through the stack pads. For example, as shown in FIG. 2, different stack signals (that is, a power supply voltage Vcc and a ground voltage GND) may be applied to the memory dies 100 and 200, respectively. A stack state of the memory dies 100 and 200, for example, an addressing order of the memory dies 100 and 200, may be determined by the stack signals. That is, addresses for accessing the memory dies 100 and 200 may be distinguished according to the stack state. For example, when address 1 to address 200 are provided to the multi-chip package memory device 500, the address 1 to the address 100 may be provided to the memory die 100 and the address 101 to the address 200 may be provided to the memory 200.

Control signals which are provided to the memory dies 100 and 200 may be signals for controlling operations of the memory dies 100 and 200, such as commands and addresses. For instance, the control signals may be provided through the control signal pads. In another instance, the control signals may be provided through the data pads in an input/output multiplexing scheme. That is to say, the control signals may be provided through the data pads, and signals provided through the data pads may be determined based on whether they are the commands, the addresses, or the data, according to the control signals provided through control signal pads.

As described above, the chip enable signal (CE) pads, the control signal pads, the data pads and the power (Vcc and GND) pads of the memory dies 100 and 200 may be connected with each other. In other words, the memory dies 100 and 200 may share a chip enable signal, control signals, and data. Accordingly, the memory dies 100 and 200 may perform the same operations before addresses for selecting the memory dies 100 and 200 are provided. Further, the memory dies 100 and 200 may perform the same operations after the addresses for selecting the memory dies 100 and 200 are provided, except actual operations for programming or reading data.

This means that unnecessary current of a memory die, which is deactivated, that is, not selected, according to an address may flow according to the shared chip enable signal or control signals. According to an embodiment of the present invention, each of the memory dies 100 and 200 included in the multi-chip package memory device 500 may pre-decode an address, and, an input/output buffer block of a non-selected memory die may be deactivated according to the decoding result. Such a configuration and operations of a memory die will be described below in detail with reference to accompanying drawings.

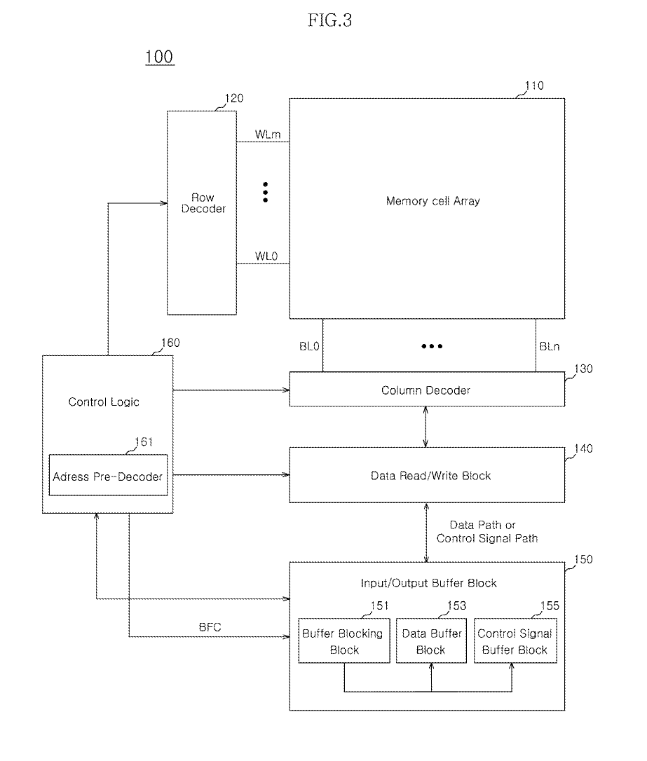

In FIG. 3, the memory die 100 and the memory die 200 included in the multi-chip package memory device 500 may be configured to have the same structure and perform the same operations. Thus, for the sake of convenience in explanation, the configuration and operations of the memory die 100 will be described below.

Referring to FIG. 3, the memory die 100 may include a memory cell array 110, a row decoder 120, a column decoder 130, a data read/write block 140, an input/output buffer block 150, and a control logic 160.

The memory cell array 110 may include memory cells for storing data provided from an external device (not shown). The memory cells included in the memory cell array 110 may be arranged in regions where word lines WL0 to WLm and bit lines BL0 to BLn intersect. The memory cell array 110 may be formed to have a single-layer array structure (a two-dimensional array structure) or a multi-layer array structure (a three-dimensional array structure).

The row decoder 120 may be electrically coupled to the memory cell array 110 through the word lines WL0 to WLm. The row decoder 120 may operate under the control of the control logic 160. The row decoder 120 may be configured to decode an address which is pre-decoded through an address pre-decoder 161 included in the control logic 160. The row decoder 120 may be configured to select and drive the word lines WL0 to WLm according to a decoding result. For instance, the row decoder 120 may provide an operating voltage provided from a voltage generator (not shown), to the respective word lines WL0 to WLm.

The column decoder 130 may be electrically coupled to the memory cell array 110 through the bit lines BL0 to BLn. The column decoder 130 may operate under the control of the control logic 160. The column decoder 130 may be configured to decode an address which is pre-decoded through the address pre-decoder 161 included in the control logic 160. The column decoder 130 may be configured to sequentially connect the bit lines BL0 to BLn with the data read/write block 140 by a predetermined unit according to a decoding result.

The data read/write block 140 may operate under the control of the control logic 160. The data read/write block 140 may be configured to operate as a write driver or a sense amplifier according to an operation mode. For example, the data read/write block 140 may be configured to store data provided from an external device (not shown) to the memory cell array 110 in a program operation. In another example, the data read/write block 140 may be configured to sense or read data from the memory cell array 110 in a read operation.

The input/output buffer block 150 may include a buffer blocking block 151, a data buffer block 153, and a control signal buffer block 155. The buffer blocking block 151 may be configured to deactivate operations of the data buffer block 153 and the control signal buffer block 155 according to a buffer control signal BFC which is provided from the control logic 160. This will be described later in detail.

The data buffer block 153 may be configured to buffer data inputted through data pads (not shown) and provide buffered data to the data read/write block 140. Further, the data buffer block 153 may be configured to buffer data provided from the data read/write block 140 and output the buffered data to an external device through the data pads. The data buffer block 153 may include latch circuits (not shown) and an output driving circuit (not shown).

The control signal buffer block 155 may be configured to buffer control signals inputted through control signal pads and provide the buffered control signals to the data read/write block 140 or the control logic 160. For instance, the control signals may be all signals for controlling operations of the memory die 100, such as read, write (or program) and erase operations.

The control logic 160 may be configured to control general operations of the memory die 100 in response to the control signals provided from the external device. For example, the control logic 160 may control the read, write (or program) and erase operations of the memory die 100.

The control logic 160 may include the address pre-decoder 161. The address pre-decoder 161 may be configured to pre-decode an address which is inputted through the input/output buffer block 150. The control logic 160 may determine whether the inputted address is an address included in an operating address range, on the basis of the pre-decoded address. Operating addresses may be defined as addresses which are allocated to the memory dies 100 and 200 to access the respective memory dies 100 and 200. For example, the control logic 160 may determine whether the inputted address is an address for accessing the memory die 100, on the basis of the decoded address.

If it is determined that the inputted address is not an address for accessing the memory die 100, the control logic 160 may deactivate the input/output buffer block 150. For example, if it is determined that the inputted address is not an address for accessing the memory die 100, the control logic 160 may provide the buffer control signal BFC, which is deactivated, to the buffer blocking block 151. According to the deactivated buffer control signal BFC, the buffer blocking block 151 may deactivate the data buffer block 153 and the control signal buffer block 155.

Even though data are inputted through the data pads, the data buffer block 153 deactivated by the buffer blocking block 151 may not buffer the data or transfer the data to the data read/write block 140 through data paths. Also, since data is not transmitted through the data paths, the data read/write block 140 may not perform an actual operation for processing data.

Even though control signals are inputted through the control signal pads, the control signal buffer block 155 deactivated by the buffer blocking block 151 may not buffer the control signals or transfer the control signals to the data read/write block 140 through control signal paths. Also, since control signals are not transmitted through the control signal paths, the data read/write block 140 may not perform an actual operation for responding to the control signals.

Even though the control signals or data shared between the memory dies 100 and 200 are inputted to the input/output buffer block 150 through the pads, the input/output buffer block 150 may not operate in response to the control signals or data. Furthermore, a circuit block which is provided with the data or control signals from the input/output buffer block 150 may not operate as well. Thus, the operating current or standby current to be consumed by the non-selected memory die among memory dies included in the multi-chip package memory device may be reduced.

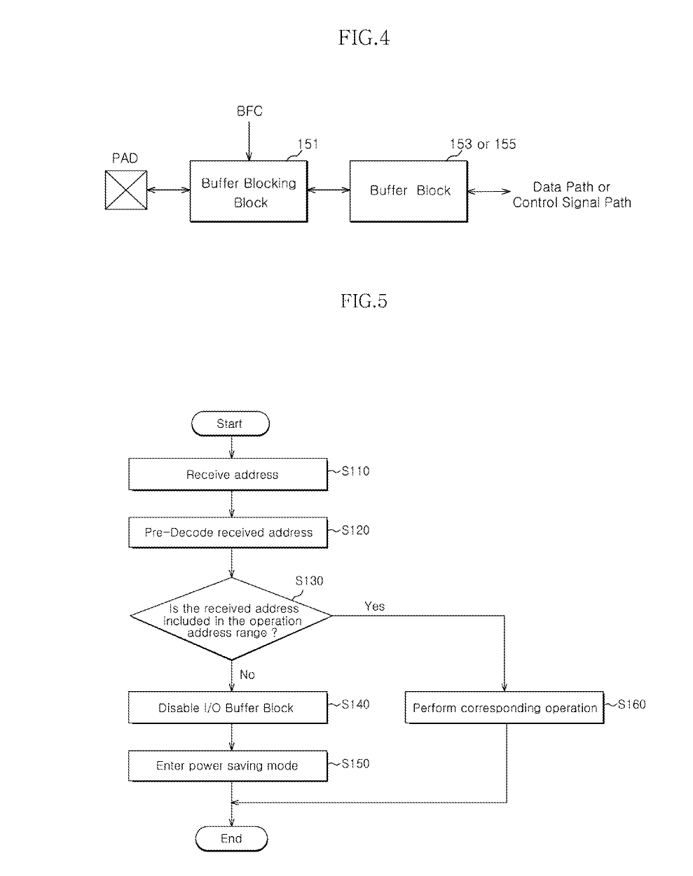

Referring to FIG. 4, the buffer blocking block 151 may be configured to deactivate the buffer blocks 153 or 155 according to the deactivated buffer control signal BFC. The buffer block shown in FIG. 4 may represent any one of the data buffer block 153 and the control signal buffer block 155 of FIG. 3.

For instance, the buffer blocking block 151 may be configured to block signal transfer paths between the pads and the buffer blocks 153 or 155 according to the deactivated control signal BFC. According to this configuration, even though data or control signals are inputted through the pads, the data or control signals may not be transferred to the buffer block 153 or 155. Therefore, the buffer blocks 153 or 155 may not continue to operate. Thus, signals may not be transferred through data paths or control signal paths.

In describing FIG. 5, it is assumed that the memory die 100 or 200 (see FIG. 1) receives a command for performing an operation before receiving an address and enters a procedure for receiving an address or an additional command according to the received command.

Referring to FIG. 5, in step S110, the memory die may receive an address. In step S120, the memory die may pre-decode the received address. The memory die may determine whether the received address is included in an operating address range, according to a pre-decoding result. In other words, as mentioned above, the memory die may determine whether the received address is an address allocated to the memory die itself, on the basis of the decoded address. According to a determination result, the procedure may branch to step S140 and step S160.

In step S140, when it is determined that the received address is not included in the operating address range (the “No” path in step S130), the memory die may deactivate the input/output buffer block. Deactivation of the input/output buffer block may be implemented by blocking the signal transfer paths between the pads and the buffer block through the buffer blocking block (see the reference numeral 151 of FIG. 2).

In step S150, the memory die may enter a power saving mode after the input/output buffer block is deactivated. Namely, as the memory die deactivates the input/output buffer block, the memory die may enter the power saving mode to prevent power consumption due to unnecessary operations of other circuit blocks.

In step S160, when it is determined that the received address is included in the operating address range (the “Yes” path in step S130), the memory die may perform a corresponding operation on the basis of the received address.

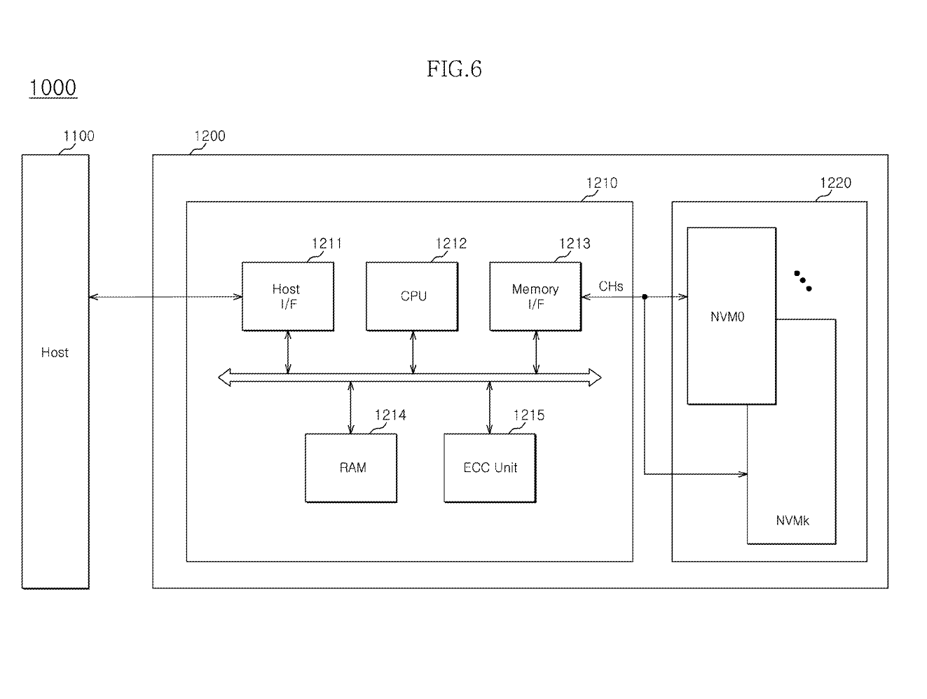

Referring to FIG. 6, a data processing system 1000 may include a host 1100 and a data storage device 1200. The data storage device 1200 may include a controller 1210 and a data storage medium 1220. The data storage device 1200 may be used by being connected to the host 1100 such as a desktop computer, a notebook computer, a digital camera, a mobile phone, an MP3 player, a game machine, and the like. The data storage device 1200 may also be referred to as a memory system.

The controller 1210 may be connected to the host 1100 and the data storage medium 1220 and configured to access the data storage medium 1220 in response to a request from the host 1100. For example, the controller 1210 may be configured to control the read, program or erase operation of the data storage medium 1220. The controller 1210 may be configured to drive a firmware for controlling the data storage medium 1220.

The controller 1210 may include well-known components such as a host interface 1211, a central processing unit (CPU) 1212, a memory interface 1213, a RAM 1214, and an error correction code (ECC) unit 1215.

The central processing unit 1212 may be configured to control the general operations of the controller 1210 in response to a request from the host 1100. The RAM 1214 may be used as a working memory of the central processing unit 1212 and may temporarily store the data read from the data storage medium 1220 or the data provided from the host 1100.

The host interface 1211 may be configured to interface the host 1100 and the controller 1210. For example, the host interface 1211 may be configured to communicate with the host 1100 through one of various interface protocols such as a USB (universal serial bus) protocol, an MMC (multimedia card) protocol, a PCI (peripheral component interconnection) protocol, a PCI-E (PCI-express) protocol, a PATA (parallel advanced technology attachment) protocol, a SATA (serial ATA) protocol, an SCSI (small computer small interface) protocol, an SAS (serial attached SCSI) protocol, and an IDE (integrated drive electronics) protocol.

The memory interface 1213 may be configured to interface the controller 1210 with the data storage medium 1220 and configured to provide a command and an address to the data storage medium 1220 under the control of the central processing unit 1212. Furthermore, the memory interface 1213 may be configured to exchange data with the data storage medium 1220.

The data storage medium 1220 may include a plurality of nonvolatile memory devices NVM0 to NVMk each of which may be constituted by the multi-chip package memory device (the reference numeral 500 of FIG. 1) in accordance with an embodiment of the present invention. As each of the nonvolatile memory devices NVM0 to NVMk may be constituted by the multi-chip package memory device (the reference numeral 500 of FIG. 1) in accordance with an embodiment of the present invention, power consumption of the data storage device 1200 may be reduced.

The error correction code unit 1215 may be configured to detect an error of the data read from the data storage medium 1220. Also, the error correction code unit 1215 may be configured to correct the detected error when the detected error falls within a correction range. The error correction code unit 1215 may be provided inside or outside the controller 1210 depending on the memory system 1000.

The controller 1210 and the data storage medium 1220 may be configured as a solid state drive (SSD).

As another example, the controller 1210 and the data storage medium 1220 may be integrated into one semiconductor apparatus and may be configured as a memory card. For example, the controller 1210 and the data storage medium 1220 may be integrated into one semiconductor apparatus and may be configured as a PCMCIA (personal computer memory card international association) card, a CF (compact flash) card, a smart media card, a memory stick, a multimedia card (MMC, RS-MMC and MMC-micro), an SD (secure digital) card (SD, Mini-SD and Micro-SD), a UFS (universal flash storage), etc.

In another example, the controller 1210 or the data storage medium 1220 may be mounted as various types of packages. For example, the controller 1210 or the data storage medium 1220 may be mounted by being packaged into types such as a POP (package on package), a ball grid array (BGA) package, a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat package (MQFP), a thin quad flat package (TQFP), a small outline IC (SOIC), a shrink small outline package (SSOP), a thin small outline package (TSOP), a thin quad flat package (TQFP), a system in package (SIP), a multi-chip package (MCP), a wafer-level fabricated package (WFP), and a wafer-level processed stack package (WSP).

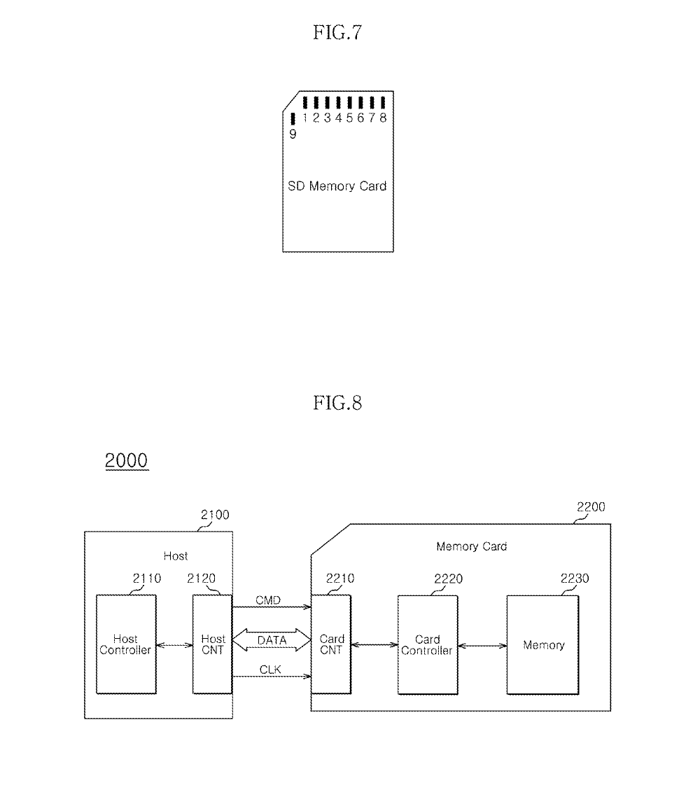

Referring to FIG. 7, the SD card may include one command pin (for example, a second pin), one clock pin (for example, a fifth pin), four data pins (for example, first, seventh, eighth and ninth pins), and three power pins (for example, third, fourth and sixth pins).

Through the command pin (the second pin), a command and a response signal may be transmitted. In general, the command may be transmitted to the SD card from a host, and the response signal may be transmitted to the host from the SD card.

The data pins (the first, seventh, eighth and ninth pins) may be divided into reception (Rx) pins for receiving data transmitted from the host and transmission (Tx) pins for transmitting data to the host. The reception (Rx) pins and the transmission (Tx) pins may be provided in pairs to transmit differential signals.

The SD card may include the multi-chip package memory device (the reference numeral 500 of FIG. 1) in accordance with an embodiment of the present invention and a controller for controlling such memory device. The controller included in the SD card may be the same or substantially similar in configuration and function as the controller 1210 described above with reference to FIG. 6. As the SD card may include the multi-chip package memory device (the reference numeral 500 of FIG. 1) in accordance with an embodiment of the present invention, power consumption of the SD card may be reduced.

Referring to FIG. 8, a data processing system 2000 may include a host 2100 and a memory card 2200. The host 2100 may include a host controller 2110 and a host connection unit 2120. The memory card 2200 may include a card connection unit 2210, a card controller 2220, and a memory device 2230.

The host connection unit 2120 and the card connection unit 2210 may include a plurality of pins. The pins may include a command pin, a clock pin, a data pin, and a power pin. The number of pins may vary depending on the kind of the memory card 2200.

The host 2100 may store data in the memory card 2200 or may read data stored in the memory card 2200.

The host controller 2110 may transmit a write command CMD, a clock signal CLK generated from a clock generator (not shown) in the host 2100, and data DATA to the memory card 2200 through the host connection unit 2120. The card controller 2220 may operate in response to the write command received through the card connection unit 2210. The card controller 2220 may store the received data DATA in the memory device 2230, using a clock signal generated from a clock generator (not shown) in the card controller 2220, according to the received clock signal CLK.

The host controller 2110 may transmit a read command CMD and a clock signal CLK generated from a clock generator (not shown) in the host 2100 to the memory card 2200 through the host connection unit 2120. The card controller 2220 may operate in response to the read command received through the card connection unit 2210. The card controller 2220 may read data from the memory device 2230 using a clock signal generated from a clock generator (not shown) in the card controller 2220, according to the received clock signal CLK, and may transmit the read data to the host controller 2110.

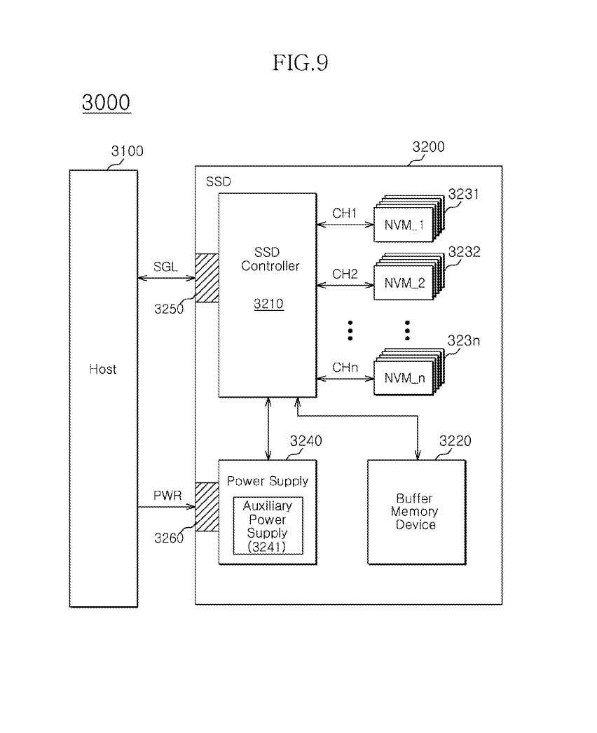

Referring to FIG. 9, a data processing system 3000 may include a host 3100 and an SSD 3200.

The SSD 3200 may include an SSD controller 3210, a buffer memory device 3220, nonvolatile memory devices 3231 to 323n, a power supply 3240, a signal connector 3250, and a power connector 3260.

The SSD 3200 may operate in response to a request from the host 3100. The SSD controller 3210 may be configured to access the nonvolatile memory devices 3231 to 323n in response to a request from the host 3100. For example, the SSD controller 3210 may be configured to control read, program and erase operations of the nonvolatile memory devices 3231 to 323n.

The buffer memory device 3220 may be configured to temporarily store data which are to be stored in the nonvolatile memory devices 3231 to 323n. Further, the buffer memory device 3220 may be configured to temporarily store data which are read from the nonvolatile memory devices 3231 to 323n. The data temporarily stored in the buffer memory device 3220 may be transmitted to the host 3100 or the nonvolatile memory devices 3231 to 323n under the control of the SSD controller 3210.

The nonvolatile memory devices 3231 to 323n may be used as storage media of the SSD 3200. Each of the nonvolatile memory devices 3231 to 323n may be constituted by the multi-chip package memory device (the reference numeral 500 of FIG. 1) in accordance with an embodiment of the present invention. Thus, power consumption of the SSD 3200 may be reduced.

The nonvolatile memory devices 3231 to 323n may be connected to the SSD controller 3210 through a plurality of channels CH1 to CHn, respectively. One or more nonvolatile memory devices may be connected to one channel. The nonvolatile memory devices connected to one channel may be connected to the same signal bus and data bus.

The power supply 3240 may be configured to provide power PWR inputted through the power connector 3260 to the internal components of the SSD 3200. The power supply 3240 may include an auxiliary power supply 3241. The auxiliary power supply 3241 may be configured to supply power so as to allow the SSD 3200 to be normally terminated when sudden power-off occurs. The auxiliary power supply 3241 may include super capacitors capable of being charged with power PWR.

The SSD controller 3210 may exchange a signal SGL with the host 3100 through the signal connector 3250. Here, the signal SGL may include a command, an address, data, and the like. The signal connector 3250 may by constituted by a connector such as PATA (parallel advanced technology attachment), SATA (aerial advanced technology attachment), SCSI (small computer small interface), SAS (serial SCSI), and the like, according to an interface scheme between the host 3100 and the SSD 3200.

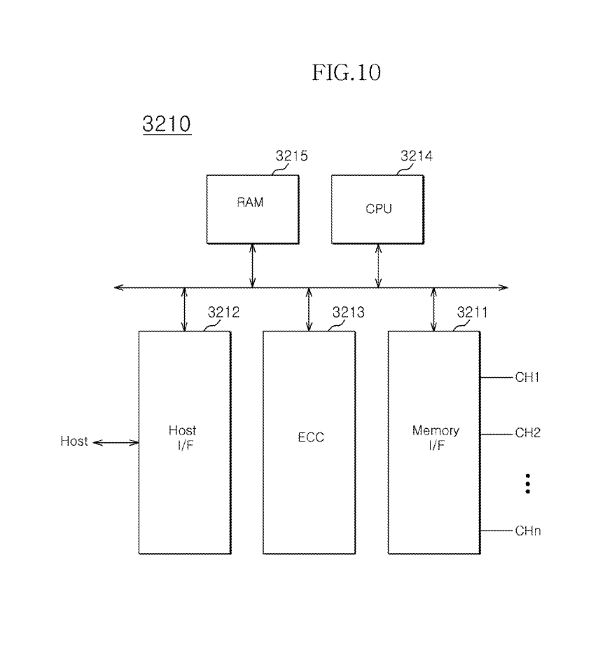

Referring to FIG. 10, the SSD controller 3210 may include a memory interface 3211, a host interface 3212, an ECC unit 3213, a central processing unit 3214, and a RAM 3215.

The memory interface 3211 may be configured to provide a command and an address to the nonvolatile memory devices 3231 to 323n. Moreover, the memory interface 3211 may be configured to exchange data with the nonvolatile memory devices 3231 to 323n. The memory interface 3211 may scatter data transmitted from the buffer memory device 3220 to the respective channels CH1 to CHn, under the control of the central processing unit 3214. Furthermore, the memory interface 3211 may transmit data read from the nonvolatile memory devices 3231 to 323n to the buffer memory device 3220, under the control of the central processing unit 3214.

The host interface 3212 may be configured to provide an interface with the SSD 3200 in correspondence to the protocol of the host 3100. For example, the host interface 3212 may be configured to communicate with the host 3100 through one of PATA (parallel advanced technology attachment), SATA (serial advanced technology attachment), SCSI (small computer small interface) and SAS (serial SCSI) protocols. In addition, the host interface 3212 may perform a disk emulation function of supporting the host 3100 to recognize the SSD 3200 as a hard disk drive (HDD).

The ECC unit 3213 may be configured to generate parity bits based on the data transmitted to the nonvolatile memory devices 3231 to 323n. The generated parity bits may be stored in spare areas of the nonvolatile memory devices 3231 to 323n. The ECC unit 3213 may be configured to detect errors in data read from the nonvolatile memory devices 3231 to 323n. When the detected error falls within a correction range, the ECC unit 3213 may be configured to correct the detected error.

The central processing unit 3214 may be configured to analyze and process a signal SGL inputted from the host 3100. The central processing unit 3214 may control general operations of the SSD controller 3210 in response to a request from the host 3100. The central processing unit 3214 may control the operations of the buffer memory device 3220 and the nonvolatile memory devices 3231 to 323n according to a firmware for driving the SSD 3200. The RAM 3215 may be used as a working memory device for driving the firmware.

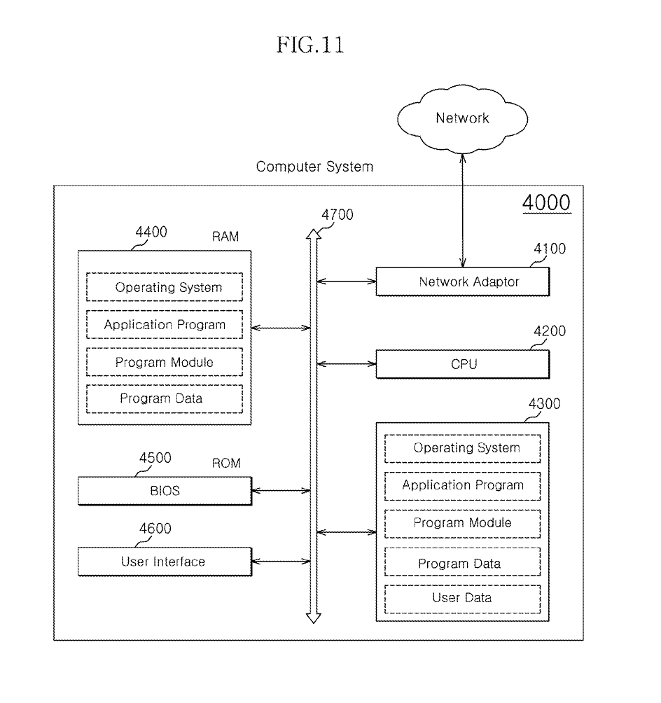

Referring to FIG. 11, a computer system 4000 may include a network adaptor 4100, a central processing unit 4200, a data storage device 4300, a RAM 4400, a ROM 4500 and a user interface, which may be electrically connected to a system bus 4700. The data storage device 4300 may be constituted by the data storage device 1200 shown in FIG. 6 or the SSD 3200 shown in FIG. 9.

The network adaptor 4100 may provide interfacing between the computer system 4000 and external networks. The central processing unit 4200 may perform general operation processing for driving an operating system residing at the RAM 4400 or an application program.

The data storage device 4300 may store general data necessary in the computer system 4000. For example, an operating system for driving the computer system 4000, an application program, various program modules, program data and user data may be stored in the data storage device 4300.

The RAM 4400 may be used as a working memory device of the computer system 4000. Upon booting, the operating system, the application program, the various program modules and the program data necessary for driving programs, which are read from the data storage device 4300, may be loaded on the RAM 4400. A BIOS (basic input/output system) which is activated before the operating system may be driven and may be stored in the ROM 4500. Information exchange between the computer system 4000 and a user may be implemented through the user interface 4600.

Although not shown in a drawing, it is to be readily understood that the computer system 4000 may further include devices such as an application chipset, a camera image processor (CIS), and the like.

As is apparent from the above descriptions, according to embodiments of the present invention, power consumption of a memory device and a multi-chip package memory device including the same can be reduced.

While certain embodiments have been described above, it will be understood to those skilled in the art that the embodiments described are by way of example only. Accordingly, the memory device, the operating method thereof, and the data storage device including the same described herein should not be limited based on the described embodiments. Rather, the memory device, the operating method thereof and the data storage device including the same described herein should only be limited in light of the claims that follow when taken in conjunction with the above description and accompanying drawings.

What is claimed is:

1. A memory device comprising:
a data read/write block configured to store data in memory cells and read data from the memory cells;
an input/output buffer block configured to buffer data which is provided from the data read/write block or to the data read/write block; and
a control logic configured to activate or deactivate the input/output buffer block based on an address which is inputted from an external device.

2. The memory device according to claim 1, wherein the input/output buffer block is configured to input data inputted through data pads and control signals inputted through control signal pads, and provide buffered input data and control signals to the data read/write block, and buffer read data read out through the data read/write block, and output buffered read data to an external device through the data pads.

3. The memory device according to claim 1,
wherein the control logic includes an address pre-decoder configured to pre-decode the inputted address, and
wherein the control logic is configured to determine whether the inputted address is included in an operating address range allocated to access the memory device, based on a decoding result of the address pre-decoder.

4. The memory device according to claim 3, wherein the control logic is configured to activate the input/output buffer block when it is determined that the inputted address is included in the operating address range.

5. The memory device according to claim 3, wherein the control logic is configured to deactivate the input/output buffer block when it is determined that the inputted address is out of the operating address range.

6. The memory device according to claim 2, wherein the input/output buffer block comprises:
a data buffer block configured to buffer the input data and buffer the read data;
a control signal buffer block configured to buffer the control signals; and
a buffer blocking block configured to deactivate the data buffer block and the control signal buffer block according to a deactivated buffer control signal which is provided from the control logic.

7. The memory device according to claim 6, wherein the buffer blocking block is configured to deactivate the data buffer block by blocking signal paths between the data pads and the data buffer block.

8. The memory device according to claim 6, wherein the buffer blocking block is configured to deactivate the control signal buffer block by blocking signal paths between the control signal pads and the control signal buffer block.

9. An operating method of a memory device, comprising:
receiving an address;
pre-decoding the received address;
determining whether the received address is included in an operating address range allocated for accessing the memory device, based on a result of pre-decoding the received address; and
controlling an input/output buffer block of the memory device whether the input/output buffer block of the memory device is activated or deactivated, based on the determining result.

10. The operating method according to claim 9, wherein the input/output buffer block is activated when it is determined that the received address is included in the operating address range.

11. The operating method according to claim 9, wherein the input/output buffer block is deactivated when it is determined that the received address is out of the operating address range.

12. The operating method according to claim 10, further comprising:
entering a power saving mode when the input/output buffer block is deactivated.

13. The operating method according to claim 9, further comprising:
receiving a command for operating the memory device, before the receiving of the address.

14. A data storage device comprising:
a multi-chip package memory device including a plurality of memory devices; and
a controller configured to control the multi-chip package memory device,
wherein each of the plurality of memory devices comprises:
a data read/write block configured to store data in memory cells and read data from the memory cells;
an input/output buffer block configured to buffer input data inputted through data pads and control signals inputted through control signal pads, and provide buffered input data and control signals to the data read/write block, and buffer read data read out through the data read/write block, and output buffered read data to an external device through the data pads; and
a control logic configured to activate or deactivate the input/output buffer block based on an address which is inputted from the external device.

15. The data storage device according to claim 14,
wherein the control logic includes an address pre-decoder configured to pre-decode the inputted address, and
wherein the control logic is configured to determine whether the inputted address is included in an operating address range allocated to access the memory device, based on a decoding result of the address pre-decoder.

16. The data storage device according to claim 15, wherein the control logic is configured to activate the input/output buffer block when it is determined that the inputted address is included in the operating address range.

17. The data storage device according to claim 15, wherein the control logic is configured to deactivate the input/output buffer block which is arranged in non-selected memory device when it is determined that the inputted address is out of the operating address range.

18. The data storage device according to claim 14, wherein the input/output buffer block comprises:
a data buffer block configured to buffer the input data and buffer the read data;
a control signal buffer block configured to buffer the control signals; and
a buffer blocking block configured to deactivate the data buffer block and the control signal buffer block according to a deactivated buffer control signal which is provided from the control logic.

19. The data storage device according to claim 18, wherein the buffer blocking block is configured to deactivate the data buffer block by blocking signal paths between the data pads and the data buffer block.

20. The data storage device according to claim 18, wherein the buffer blocking block is configured to deactivate the control signal buffer block by blocking signal paths between the control signal pads and the control signal buffer block.
